(19) United States
(12) Patent Application Publication
(10) Pub. No.: US 2026/0154468 A1
(43) Pub. Date: Jun. 4, 2026

(54) FRAMEWORK FOR CONVEX APPROXIMATIONS OF COMPLEX CONTACT MODELS

(71) Applicant: Toyota Research Institute, Inc., Los Altos, CA (US)

(72) Inventors: Joseph Masterjohn, Boston, MA (US); Alejandro Castro, Somerville, MA (US); Xuchen Han, Sunnyvale, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/968,459

(22) Filed: Dec. 4, 2024

Related U.S. Application Data
(60) Provisional application No. 63/727,393, filed on Dec. 3, 2024.

(51) Int. Cl. G06F 30/17; G06F 17/13; G06F 30/20; G06F 111/10

(52) U.S. Cl. CPC G06F 30/17; G06F 17/13; G06F 30/20; G06F 2111/10

(57) ABSTRACT

A method may include receiving a model of contact forces, processing the model to obtain a convex approximation of the model satisfying a curl condition, and using the approximation of the model to simulate a mechanical system with frictional contact over time.

### CROSS-REFERENCE TO RELATED APPLICATION

The present specification is based on, and claims priority from U.S. Provisional Application No. 63/727,393 filed Dec. 3, 2024, the disclosure of which is hereby incorporated by reference in its entirety.

### TECHNICAL FIELD

The present specification relates to irrotational contact fields, and more particularly, to a framework for convex approximations of complex contact models.

### BACKGROUND

Simulation of multibody systems with frictional contact is critical for robotics, supporting hardware optimization, controller design, and data generation for machine learning. Accurate physics models enable advanced control and trajectory optimization, but robust, accurate, and efficient simulations for contact-rich scenarios remain challenging. Existing formulations are often computationally intractable or unsolvable, highlighting the need for practical, tractable approaches. Accordingly, a need exists for a novel framework for generating convex approximations of engineering-grade contact models, with the potential to reduce the sim-to-real gap.

### SUMMARY

In one embodiment, a method may include receiving a model of contact forces, processing the model to obtain a convex approximation of the model satisfying a curl condition, and using the approximation of the model to simulate a mechanical system with frictional contact over time.

In another embodiment, a computing device may include one or more processors configured to receive a model of contact forces, process the model to obtain a convex approximation of the model satisfying a curl condition, and use the approximation of the model to simulate a mechanical system with frictional contact over time.

In another embodiment a non-transitory computer-readable storage medium may store machine readable instructions in or more memory modules that cause one or more processors to receive a model of contact forces, process the model to obtain a convex approximation of the model satisfying a curl condition, and use the approximation of the model to simulate a mechanical system with frictional contact over time.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1 depicts a schematic diagram of a computing device for convex approximations of complex contact models, according to one or more embodiments shown and described herein;

FIG. 2 schematically depicts memory modules of the computing device of FIG. 1, according to one or more embodiments shown and described herein;

FIG. 3 depicts a plot of contour levels associated with a convex approximation, according to one or more embodiments shown and described herein;

FIG. 4 depicts a table of properties and artifacts of three different model approximations, according to one or more embodiments shown and described herein;

FIG. 5 depicts a mechanical system including an oscillating conveyor belt;

FIG. 6A depicts a plot of contact velocities associated with the system of FIG. 5;

FIG. 6B depicts a plot of contact forcers associated with the system of FIG. 5;

FIG. 7 depicts a convergence study associated with the system of FIG. 5;

FIG. 8 depicts a mechanical system including a falling sphere;

FIG. 9A depicts a plot of contact velocities associated with the system of FIG. 8;

FIG. 9B depicts a plot of forces associated with the system of FIG. 8;

FIG. 10 depicts a convergence study associated with the system of FIG. 8;

FIG. 11 depicts a mechanical system including a sliding rod;

FIG. 12A depicts a plot of contact forces associated with the system of FIG. 11 in a case with zero dissipation;

FIG. 12B shows a close-up of the plot of FIG. 12A near the impact;

FIG. 13A depicts contact velocities associated with the system of FIG. 11 in a case with zero dissipation;

FIG. 13B shows a close-up of the plot of FIG. 13A near the impact;

FIG. 14A depicts a plot of contact forces associated with the system of FIG. 11 in a case with dissipation;

FIG. 14B shows a close-up of the plot of FIG. 14A near the impact;

FIG. 15A depicts a plot of contact velocities associated with the system of FIG. 11 in a case with dissipation;

FIG. 15B shows a close-up of the plot of FIG. 15A near the impact;

FIG. 16A depicts a convergence study associated with the system of FIG. 11 in a case with dissipation;

FIG. 16B depicts a convergence study associated with the system of FIG. 11 in a case without dissipation; and

FIG. 17 depicts a flowchart of an example method for operating the computing device of FIG. 1, according to one or more embodiments shown and described herein.

### DETAILED DESCRIPTION

Rigid body dynamics with frictional contact are complicated by non-smooth solutions. Acceleration-level formulations can lead to singular configurations, known as Painlevé paradoxes, where solutions may not exist. Discrete velocity-level formulations circumvent this by allowing discrete velocity jumps and impulsive forces. While many variants exist, the general form of a discrete formulation enforces balance of momentum subject to contact constraints, with additional constraints to incorporate Coulomb's law of friction under the maximum dissipation principle. With the addition of decision variables and Lagrange multipliers, the result is a large and challenging to solve Non-linear Complementarity Problem (NCP) with a much larger number of variables than the original problem.

Solving NCPs robustly and efficiently has remained elusive. NCPs are equivalent to a non-convex global optimization problem, which are generally NP-hard. Therefore, NCPs may lack solutions or have multiple solutions. In practice, iterative solvers might incorrectly assume convergence or terminate early, leading to solutions that fail to satisfy the original equations or violate physical laws.

There are other, less frequently discussed issues—numerical conditioning and implementation details—that affect convergence properties and robustness. These are important problems with it comes to the simulation of complex systems, with either many degrees of freedom (DOFs), a large number of constraints, or both. Solutions that work for small systems often do not work when faced with real-world engineering applications.

The embodiments disclosed herein are directed to a framework for generating convex approximations of complex contact models In particular, a novel framework is disclosed for generating convex approximations of engineering-grade contact models, with the potential to reduce the sim-to-real gap. The disclosed framework may receive a model of contact forces, and process the model to obtain a convex approximation of the model. The convex approximation may be used to simulate a mechanical system with frictional contact.

One technique for modeling compliant contact is a convex Semi-Analytic Primal (SAP) formulation introduced in A. M. Castro, F. N. Permenter and X. Han, “An unconstrained convex formulation of compliant contact,” IEEE Transactions on Robotics, 2022. The SAP formulation embraces compliance to provide a robust and performant tool that targets robotics applications—where grippers feature compliant surface for stable grasps, and robotic feet are often padded with compliant materials. Although the formulation is inherently compliant, rigid contact can be modeled to good approximation using a near-rigid approximation. The SAP model focuses on physical correctness, numerical conditioning, and robustness.

However, the SAP formulation has a number of limitations. The most well-known is the artifact of gliding during slip. In the SAP formulation, the gliding effect is proportional to dissipation and does not vanish as time step goes to zero. This is nonphysical and makes parameter selection a cumbersome trade-off between physical accuracy and the magnitude of the gliding artifact. Finally, the SAP model of compliance is intrinsic to its convex formulation, and therefore it is not possible to incorporate other well-known and experimentally validated models of contact. Accordingly, embodiments disclosed herein extend the SAP formulation to reduce and even eliminate many of these limitations, while preserving its convexity along with its convergence and robustness guarantees.

In embodiments, the disclosed framework can generate convex approximations of arbitrarily complex contact models. SAP is extended by introducing incremental potential, along with necessary conditions for existence and convexity of an incremental potential. In embodiments, the disclosed framework may incorporate Coulomb friction independent of the complexity of the compliant contact model. The disclosed framework supports arbitrary forms of regularization, facilitating the design of accurate models with desirable numerical properties. An example convex approximation of compliant contact is present with Hunt & Crossly dissipation. In embodiments, the same framework can be used to incorporate barrier functions to model rigid contact.

In embodiments, a state of a mechanical system may be described by generalized positions q∈ [symbol] and generalized velocities v∈ [symbol] , where n_{q} and nᵥ are the number of generalized positions and velocities, respectively. Time derivatives of the generalized positions relate to the generalized velocities by the kinematic map \dot{q}=N(q)v. Joint coordinates are used to describe articulated rigid bodies.

Consider a system with ne constraints introducing n_{eq} constraint equations. Constraint velocities v_{c}∈ [symbol] are given by v_{c}Jv+b, where J is the stacked Jacobian for all constraints and b is a bias term. A symplectic Euler scheme with fixed time steps of size δt may be written as:

$$M ( {q}_{0} ) ( v - {v}_{0} ) = δ {tk}_{2} ( {q}_{0} , {v}_{0} ) + {J ( {q}_{0} )}^{T} γ , q = {q}_{0} + δ tN ( {q}_{0} ) v , \qquad ( 1 )$$

where quantities with the naught subscript are evaluated at the previous time step tⁿ and quantities without subscripts are evaluated at the next time step tⁿ⁺¹=tⁿ+δt. M is the joint space mass matrix. Stiff terms, such as springs, and stabilizing terms, such as damping rotor inertias, are treated implicitly in k₁. Smooth, non-stiff terms such as gravity, gyroscopic forces, and feed-forward actuation are treated explicitly in k₂. Vector γ∈ [symbol] corresponds to constraint impulses.

The momentum residual m(v) is defined as m(v)=M(q₀)(v−v₀)−δtk₁(q,v)−δtk₂(q₀,v₀). The free motion velocities v* are defined as the solution to m(v*)=0, that is, the velocities the system would have in the absence of constraint forces. Equation (1) may be linearized at v=v* as:

$$A ( v - {v}^{*} ) = {J}^{T} γ , \qquad ( 2 )$$

where A is a symmetric positive-definite (SPD) approximation of the gradient of the momentum residual accurate to first order, i.e.

$${\frac{\partial m}{\partial v} \vert}_{v = {v}^{*}} = A + O ( δ t )$$

While some earlier work use A=M(q₀), the mass matrix at the previous time step, the disclosed embodiments incorporate the modeling of joint springs, damping, and rotor inertia implicitly.

Traditional NCP formulations supplement (2) with constraint equations to model contact. Additional constraint equations, slack variables, and Lagrange multipliers lead to a large and challenging-to-solve NCP. Instead, SAP follows a different approach. In particular, an unconstrained convex optimization problem for the next time step velocities can be written as follows:

$${min}_{v} {ℓ}_{p} ( v ) = \frac{1}{2} {‖ v - {v}^{*} ‖}_{A +}^{2} {ℓ}_{R} ( v ) , \qquad ( 3 )$$

where

$${‖ x ‖}_{A}^{2} = {x}^{T}$$

Ax, and [symbol] _{R}(v) is a regularizing term that penalizes contact impulses. It can be shown that SAP's formulation models linear compliant contact with a Kelvin-Voigt (linear) model of damping. The formulation is strongly convex, with convergence guarantees that lead to robust software implementations. Although the formulation is inherently compliant with regularized friction, the SAP formulation shows how rigid contact can be modeled to good approximation using a near-rigid approximation.

In embodiments disclosed herein, the formulation of equation (3) is extending by replacing the regularizer cost [symbol] _{R}(v) with a more general incremental potential [symbol] _{c}(v; x₀) to model contact and other constraints. This potential depends on the generalized velocities v, given a previous state x₀, making it inherently discrete, unlike continuous potentials like gravity or electric fields. Nonetheless, these discreet potentials have real physical relevance. The presence of the quadratic term

$${‖ x ‖}_{A}^{2}$$

ensures strong convexity of the optimization problem (3) when [symbol] _{c} is convex, guaranteeing a unique solution. Embodiments disclosed herein disclose methods of developing such convex potentials for frictional contact modeling.

Within this framework, the balance of momentum (2) is the optimality condition of (3), and impulses emerge as a result of the contact potentials

$$γ ( {v}_{c} ; {x}_{0} ) = - \frac{\partial {ℓ}_{c} ( {v}_{c} ; {x}_{0} )}{\partial {v}_{c}} , \qquad ( 4 )$$

where we use the notation

$$\frac{\partial f}{\partial x} = ∇ f ∈$$

to denote the gradient of a scalar function ƒ(x): [symbol] → [symbol] . As with SAP, we consider potential functions that are separable

$${ℓ}_{c} ( {v}_{c} ; {x}_{0} ) = {\sum }_{i = 1}^{{n}_{c}} {ℓ}_{c} ( {v}_{c , i} ; {x}_{0} ) \qquad ( 5 )$$

where v_{c} is the stacked vector of individual constraint velocities v_{c,i}. For contact constraints, we define a contact frame Cᵢ for which we arbitrarily choose the z-axis to coincide with the contact normal \hat{n}ᵢ. In this frame, the normal and tangential components of v_{c,i} are given by v_{n,i}=\hat{n}ᵢ·v_{c,i} and v_{t,i}=v_{c,i}−v_{n,i}\hat{n}ᵢ respectively, and v_{c,i}=[v_{c,i}v_{n,i}]. By convention, we define the relative contact velocity v_{c,i} and normal \hat{n}ᵢ such that v_{n,i}>0 for objects moving away from each other.

Using the separable potential in (5) and (4), the impulse vector γ is the stacked vector of individual constraint contributions

$${ℓ}_{c} ( {v}_{c , i} ; {x}_{0} ) = - \frac{\partial {ℓ}_{cd , i}}{\partial {v}_{c , i}} .$$

We highlight the dependence on the previous time step state x₀ to emphasize the discrete (or incremental) nature of these potentials and the resulting impulses. However, hereinafter, we write γᵢ(v_{c,i}) and [symbol] _{c,i}(v_{c,i}) to [symbol] shorten notation, and the functional dependence on the previous time step state is implicitly assumed.

We discuss frictionless contact first to introduce the disclosed framework and notation. We consider a generic normal force model

$${f}_{n} ( ϕ , {v}_{n} ) , \qquad ( 6 )$$

as a function of the signed distance φ (defined negative when objects overlap) and the normal velocity vₙ (defined positive when objects separate). To write a discrete incremental potential, we use a first order approximation of the signed distance φ=φ₀+δtvₙ, implicit in the next time step velocity vₙ. Using this approximation, we define a discrete impulse as

$$n ( {v}_{n} ; {ϕ}_{0} ) = δ {tf}_{n} ( {ϕ}_{0} + δ {tv}_{n} , {v}_{n} ) , \qquad ( 7 )$$

and the normal impulse is γₙ(vₙ)=n(vₙ;φ₀). Therefore, the potential for such model is given by

$${ℓ}_{n} ( {v}_{n} ) = - N ( {v}_{n} ) ,$$

with N(vₙ) the antiderivative of n(vₙ), i.e. n(vₙ)=N′(vₙ).

The Hessian of this cost is

$$\frac{{\partial }^{2} {ℓ}_{n}}{\partial {v}_{n}^{2}} = - δ {t}^{2} \frac{\partial {f}_{n}}{\partial ϕ} - δ t \frac{\partial {f}_{n}}{\partial {v}_{n}} ,$$

$$and therefore$$

$$\frac{\partial {f}_{n}}{\partial ϕ} \leq 0 and \frac{\partial {f}_{n}}{\partial {v}_{n}} \leq 0 , \qquad ( 8 )$$

are sufficient conditions for the cost [symbol] ₙ(vₙ) to be convex.

Interior-point methods (IP) are the standard for solving optimization problems with inequality constraints, essential for rigid contact modeling. IP solvers can also handle a richer set of constraints, like conic constraints, as needed to model Coulomb friction. Fundamentally, IP methods replace constraints with a barrier function that penalizes infeasible solutions. Logarithmic functions are commonly used, which for rigid contact penalize distances near zero

$${ℓ}_{n} ( ϕ ) = - K ln ( ϕ ) ,$$

while penetration states (φ≤0) are infeasible. The barrier parameter k>0 is iteratively reduced to approach a rigid approximation, though it can never reach zero. Therefore, in practice, the solution is effectively compliant, with a force law that first the framework (6)

$${f}_{n} ( ϕ , {v}_{n} ) = \frac{K}{ϕ} , ϕ \geq 0. \qquad ( 9 )$$

Equation (9) has a parameter k with the unit of energy and nonphysical action at infinite distance. However, in practice, k is not exposed, but hidden as part of the solver internals. Users believe they are working with a true model of rigid contact when, in reality, the solver is using a compliant model approximation. Even if k can be reduced to very small values (according to some hidden metric), the solver often ends up solving a much more challenging problem than needed since, in reality, physical materials have finite stiffness.

Incremental Potential Contact (IPC), as disclosed in M. Li, et al. “Incremental potential contact: intersection- and inversion-free, large-deformation dynamics” ACM Trans. Graph, vol. 39, no. 4 p. 49, 2020, is an optimization-based framework to model rigid contact and guarantee intersection-free solutions. The method attains strong robustness given its implicit time-stepping scheme and line search augmented with continuous collision detection (CCD) to maintain feasibility. However, IPC formulates a non-convex optimization problem and can fall into local minima, not satisfying the original physical laws. Moreover, the method lacks convergence guarantees.

Similar to the logarithmic barrier functions of IP methods, IPC proposes a smooth C² potential

$${ℓ}_{c} ( ϕ ) = - {{K}_{IPC} ( \hat{d} - ϕ )}_{+}^{2} + ln ( ϕ / \hat{d} )$$

where (a)_{+=max(0,a),k}_{_{IPC}} is a parameter automatically adjusted to improve numerical conditioning, and \hat{d} is a user parameter. Typical values of \hat{d} used by the original authors in their extensive simulations test cases are in the range of 0.1 mm to 1 mm. This potential is proposed to achieve intersection-free solutions, eliminate nonphysical action at infinite distances, and maintain smoothness for better numerics. We observe that this method again fits the framework (6), with a compliant contact force law of the form

$${f}_{n} ( ϕ , {v}_{n} ) = {K}_{IPC} ( \hat{d} - ϕ ) + [ \frac{( \hat{d} - ϕ )}{ϕ} - 2 ln ( ϕ / \hat{d} ) ] ,$$

which is only non-zero for φ∈(0, \hat{d}]. Performing Taylor expansion around φ=\hat{d}, we see that

$${f}_{n} \approx 3 {{K}_{IPC} ( \hat{d} - ϕ )}_{+}^{2} / \hat{d} ,$$

and the force models a quadratic spring of stiffness K_{IPC} (with units of N/m). In the limit to φ→0⁺, the force approximates ƒₙ≈K_{IPC}\hat{d}²/φ, the interior point force (9).

In summary, this method models a thin, compliant layer around a rigid core instead of the strict non-penetration conditions largely favored in the literature. However, this indicates the levels of rigidity that can be achieved in practice.

The above disclosure demonstrates that even rigid approximations are effectively compliant when analyzed in detail. As such, embodiments disclosed herein embrace compliance to develop a physics-based model that is transparent to user.

We consider a linear elastic law in the signed distance φ with Hunt & Crossley dissipation, as disclosed in K. M. Hunt & F. R. E. Crossley, “Coefficient of Restitution Interpreted as Damping in Vibroimpact,” Journal of Applied Mechanics, vol. 42, no. 2, pp. 440-445, 06 1975. As long as conditions (8) above are met, other alternatives may be used. In practice, however, users often find the linear model satisfactory. We write this model within framework (6) as

$${f}_{n} ( ϕ , {v}_{n} ) = {k ( - ϕ )}_{+} {( 1 - d {v}_{n} )}_{+} , \qquad ( 10 )$$

where k is the linear contact stiffness and d is the Hunt & Crossley dissipation parameter. This force is zero whenever vₙ≥\hat{v} with

$$\hat{v} = min ( - {ϕ}_{0} / δ t , 1 / d ) \qquad ( 11 )$$

the minimum normal velocity for contact to break. For vₙ<\hat{v} we define the (indefinite) antiderivative N⁺(vₙ)

$${N}^{+} ( {v}_{n} ; {ϕ}_{0} ) = δ tk [ - {v}_{n} ( {ϕ}_{0} + \frac{1}{2} δ tk {v}_{n} ) + d \frac{{v}_{n}^{2}}{2} ( {ϕ}_{0} + \frac{2}{3} δ {tv}_{n} ) ] .$$

Since the impulse is zero for vₙ≥\hat{v}, its antiderivative must be constant. Therefore, we write

$$N ( {v}_{n} ) = {N}^{+} ( min ( {v}_{n} , \hat{v} ) ; {f}_{0} ) ,$$

resulting in a continuous function for all values of vₙ.

Though inherently compliant, this model effectively handles very stiff contact due to the robustness of the disclosed convex formulation. Furthermore, this model is easily extended to incorporate hydroelastic contact to model continuous contact patches.

As with normal impulses γₙ(vₙ), friction can be modeled as a continuous function of state using a regularized approximation. Consider the model of isotropic friction

$${γ}_{t} ( {v}_{c} ) = - μ f ( ‖ {v}_{t} ‖ / {ε}_{s} ) {γ}_{n} ( {v}_{n} ) \hat{t}$$

$$f ( s ) = \frac{s}{\sqrt{1 + {s}^{2}}} \qquad ( 12 )$$

$$\hat{t} = \frac{{v}_{t}}{‖ {v}_{t} ‖}$$

where the function ƒ(s)≤1 regularizes Coulomb friction with εₛ the regularization parameter. When ∥vₜ∥<<εₛ, the model behaves as viscous damping with high viscosity. When ∥vₜ∥>>εₛ, the model approximates Coulomb's law, with friction opposing slip velocity according to the maximum dissipation principle and ∥γₜ∥→μγₙ. The choice of function ƒ(s) is somewhat arbitrary, as long as ƒ(s)≤1 and ƒ(s)=0 at s=0. We choose ƒ(s) such that equation (12) can be simplified to

$${γ}_{t} ( {v}_{c} ) = - μ {γ}_{n} ( {v}_{n} ) {\hat{t}}_{s}$$

$${\hat{t}}_{s} = \frac{{v}_{t}}{\sqrt{{‖ {v}_{t} ‖}^{2} + {ε}_{s}^{2}}} \qquad ( 13 )$$

where we define the regularized or soft tangent vector \hat{t}ₛ, which can be shown to be the gradient with respect to vₜ of the soft norm

$${‖ x ‖}_{s} = \sqrt{{‖ x ‖}^{2} + {ε}_{s}^{2}} - {ε}_{s} .$$

Unlike \hat{t}, which is not well-defined at vₜ=0, \hat{t}ₛ is well-defined and continuous for all values of slip velocity. Moreover, (13) has continuous gradients, which is a desirable property since it ensures the Hessian of our convex formulation remains well-behaved, improving the convergence rate of Newton iterations.

SAP is a convex formulation of regularized friction

$${γ}_{t} ( {v}_{c} ) = - min ( \frac{‖ {v}_{t} ‖}{{R}_{t}} , μ {γ}_{n} ( {v}_{n} ) ) \hat{t} \qquad ( 14 )$$

where Rₜ is SAP's regularization parameter. However, it may be desirable to have a model superior to SAP's for two reasons. First, SAP's linear model of dissipation can lead to sever artifacts at large dissipation values. Second, although bounds on SAP's drift speed can be estimated, it is not possible to determine it precisely.

In contrast, normal impulses of the form (7) allow the incorporation of physics-based models, such as the experimentally validated Hunt & Crossley model, and drift in (12) is controlled precisely via εₛ. As such, disclosed in further detail below are the conditions for writing convex approximations of compliant models (7) with regularized friction (12).

In embodiments, we combine compliant contact with regularized friction to write

$$γ ( {v}_{c} ) = [ \begin{matrix}- μ n ( {v}_{n} ) {\hat{t}}_{s} ( {v}_{t} ) \\ n ( {v}_{n} )\end{matrix} ] . \qquad ( 15 )$$

In embodiments, equation (15) may be an example of a model of contact forces. However, this model is not necessarily the result of a potential and γ(vₙ)≠−∂ [symbol] _{c}/∂v_{c} in general. As such, it is desirable to find existence conditions for [symbol] _{c}(v) along additional conditions for convexity.

Helmholtz's theorem states that any vector field admits the decomposition into an irrotational field (zero curl) and a solenoidal field (zero divergence)

$$γ ( {v}_{c} ) = - \frac{\partial ℓ ( {v}_{c} )}{\partial {v}_{c}} + ∇ \times A ( {v}_{c} ) \qquad ( 16 )$$

with [symbol] (v_{c}) a scalar potential and A(v_{c}) a vector potential.

In embodiments, we ignore the solenoidal component and investigate irrotational fields, which satisfy the condition

$$∇ \times γ = 0 . \qquad ( 17 )$$

Equation (17) may be referred to herein as a curl condition. That is, the curl condition may be satisfied when the curl of the contact forces is zero.

The normal component in equation (17)

$$\frac{\partial {γ}_{t , 1}}{\partial {v}_{t , 2}} = \frac{\partial {γ}_{t , 2}}{\partial {v}_{t , 1}} \qquad ( 18 )$$

states that the two-dimensional field γₜ(vₜ) is irrotational in the vₜ plane. Consider the generic isotropic friction model

$${γ}_{t} = g ( ‖ {v}_{t} ‖ , {v}_{n} ) \hat{t} \qquad ( 19 )$$

whose gradient is

$$\frac{\partial {γ}_{t}}{\partial {v}_{t}} = \frac{\partial g}{\partial ‖ {v}_{t} ‖} P + g \frac{{P}^{⊥}}{‖ {v}_{t} ‖}$$

with symmetric projection matrices P and P^{⊥}. Therefore, ∂γₜ/∂vₜ is symmetric, and condition (18) is satisfied. Thus, isotropic friction fields are irrotational. While embodiments disclosed herein are directed to isotropic friction, in other examples, anisotropic friction can be incorporated within the same framework.

Finally, the tangential components in equation (17) lead to the condition

$$\frac{\partial {γ}_{t}}{\partial {v}_{n}} = \frac{\partial {γ}_{n}}{\partial {v}_{t}} , \qquad ( 20 )$$

a condition generally not met by arbitrary contact models.

In embodiments, a family of model approximations satisfying (20) and establishing conditions for convexity are disclosed. A first approximation is the SAP approximation, discussed above. In the SAP approximation, the Hessian of the regularizer cost

$$G = \frac{{\partial }^{2} ℓ}{\partial {v}_{c}^{2}} = - \frac{\partial γ}{\partial {v}_{c}} = - [ \begin{matrix}\frac{\partial {γ}_{t}}{\partial {v}_{t}} & \frac{\partial {γ}_{t}}{\partial {v}_{n}} \\ \frac{\partial {γ}_{n}^{T}}{\partial {v}_{t}} & \frac{\partial {γ}_{n}}{\partial {v}_{n}}\end{matrix} ]$$

is symmetric positive semi-definite and therefore SAP satisfies condition (2). Moreover, ∂γₜ/∂vₜ is symmetric since γₜ is of the isotropic form (19) and condition (18) is met.

Another example model approximation of the family of model approximations is a Lagged approximation disclosed herein. In this example, we use the model of regularized friction (12) in which the normal impulse is lagged to the previous time step

$${γ}_{t} ( {v}_{t} ) = - μ f ( s ) {γ}_{n , 0} \hat{t} \qquad ( 21 )$$

with s=∥vₜ∥/εₛ, and using (6), γ_{n,0}=δtƒₙ(φ₀,v_{n,0}). For a physical model of compliance for which γₙ is only a function of vₙ, condition (20) is trivially met since

$$\frac{\partial {γ}_{t}}{\partial {v}_{n}} = 0 \\ \frac{\partial {γ}_{n}}{\partial {v}_{t}} = 0$$

In this approximation, the normal impulses are still treated implicitly, with potential [symbol] =−N(vₙ) and impulse γₙ=n(vₙ). The normal impulse is only lagged in the friction model.

We verify that

$${ℓ}_{t} ( {v}_{t} ) = μ {γ}_{n 0} {ε}_{s} F ( ‖ {v}_{t} ‖ / {ε}_{s} )$$

with ƒ=F′ satisfies γₜ=−∂ [symbol] ₜ/∂vₜ. The contact potential is separable as the sum of normal and friction contributions

$$ℓ ( {v}_{c} ) = {ℓ}_{t} ( {v}_{t} ) + {ℓ}_{n} ( {v}_{n} ) .$$

The Hessian of [symbol] ₜ is given by

$$\frac{{\partial }^{2} {ℓ}_{t}}{\partial {v}_{t}^{2}} = - \frac{\partial {γ}_{t}}{\partial {v}_{t}} = μ {γ}_{n 0} [ \frac{{f}^{′} ( s )}{{ε}_{s}} P ( \hat{t} ) + \frac{f ( s )}{‖ {v}_{t} ‖} {P}^{⊥} ( \hat{t} ) ] .$$

With a non-decreasing ƒ, F is convex, and the Hessian of [symbol] ₜ is the positive linear combination of two projection matrices. Therefore, [symbol] ₜ is twice differentiable and convex. Thus, the Hessian

$$\frac{{\partial }^{2} ℓ}{\partial {v}_{c}^{2}} = - \frac{\partial γ}{\partial {v}_{c}} = [ \begin{matrix}- \frac{\partial {y}_{t}}{\partial {v}_{t}} & 0 \\ 0 & - \frac{\partial {γ}_{n}}{\partial {v}_{n}}\end{matrix} ]$$

is positive definite for physics-based models that satisfy equation (8).

The judicious choice F(s)=\sqrt{s²+1}−1 leads to expressions of the cost, gradient, and Hessian involving soft norms, which are twice differentiable and convex, even at vₜ=0

$${ℓ}_{t} ( {v}_{t} ) = μ {γ}_{n 0} {‖ {v}_{t} ‖}_{s} , {γ}_{t} = - μ {γ}_{n , 0} {\hat{t}}_{s} , \frac{{\partial }^{2} {ℓ}_{t}}{\partial {v}_{t}^{2}} = μ {γ}_{n 0} \frac{{P}^{⊥} ( {\hat{t}}_{s} )}{{‖ {v}_{t} ‖}_{s} + {ε}_{s}} .$$

Another example model approximation of the family of model approximations is a Similar approximation, as disclosed herein. Similarity solutions to partial differential equations (PDEs) are solutions which depend on certain groupings of independent variables rather than each variable individually. In particular, self-similar solutions arise when the problem lacks a characteristic time or length scale. The Blasius solution to Prandtl's boundary layer equations in fluid mechanics is a well-known and celebrated example.

Motivated by the algebraic form of SAP impulses, we propose the grouping of variables

$$z = {v}_{n} - μ {ε}_{s} F ( s ) , \qquad ( 22 )$$

where μεₛF(s) simplifies to μ∥vₜ∥ₛ when F(s)=\sqrt{s²+1}−1. Note the consistency of units in (22), an important aspect of similar solutions. With this grouping, we propose the similar solution:

$${γ}_{n} ( ‖ {v}_{t} ‖ , {v}_{b} ) = n ( z ) , {γ}_{t} ( ‖ {v}_{t} ‖ , {v}_{n} ) = - μ f ( s ) {γ}_{n} ( ‖ {v}_{t} ‖ , {v}_{n} ) \hat{t} . \qquad ( 23 )$$

Unlike the Lagged approximation, the Similar approximation strongly couples friction and normal components. However, this introduces a dependency of the normal component on slip speed, an artifact we quantify as shown below.

Differentiation of equation (23) leads to

$$\frac{\partial {γ}_{t}}{\partial {v}_{n}} = \frac{\partial {γ}_{n}}{\partial {v}_{t}} = - μ f ( s ) {n}^{′} ( z ) \hat{t} ,$$

which confirms condition (20). To find the potential, we start from the normal component of the impulse

$${γ}_{n} ( ‖ {v}_{t} ‖ , {v}_{n} ) = n ( z ) = - \frac{\partial ℓ}{\partial {v}_{n}} ,$$

and integrate on vₙ to obtain

$$ℓ ( {v}_{t} , {v}_{n} ) = - N ( z ) + G ( {v}_{t} ) ,$$

where G(vₜ) is an arbitrary function of vₜ. Taking the derivative with respect to vₜ results in

$$\frac{\partial ℓ}{\partial {v}_{t}} = μ n ( z ) f ( s ) \hat{t} + \frac{\partial G}{\partial {v}_{t}} .$$

Comparing the above equation with equation (23) reveals that we can set G=0 and obtain

$$ℓ ( ‖ {v}_{t} ‖ , {v}_{n} ) = - N ( z ) , \qquad ( 24 )$$

as the desired potential function.

The Hessian of this potential is:

$$\frac{{\partial }^{2} ℓ}{\partial {v}_{c}^{2}} = - \frac{\partial γ}{\partial {v}_{c}} = μ [ ( \frac{{f}^{′} n ( z )}{{ε}_{s}} - {n}^{′} ( z ) {f}^{2} ( s ) ) P ( \hat{t} ) + \frac{f ( s ) n ( z )}{‖ {v}_{t} ‖} {P}^{⊥} ( \hat{t} ) ] .$$

For a convex potential [symbol] ₙ, we have

$${n}^{′} = {N}^{″} = - {ℓ}_{n}^{″} \leq 0.$$

With ƒ(s) non-decreasing as in the Lagged approximation, ƒ′≥0. The Hessian

$${\partial }^{2} ℓ / \partial {v}_{c}^{2}$$

is the linear combination with positive coefficients of symmetric positive semi-definite projection matrices. Therefore, the Hessian is symmetric positive semi-definite, and the potential is convex. As before, the choice of F(s)=\sqrt{s²+1}−1 leads to continuously differentiable expressions in terms of soft norms, with no singularity at vₜ=0.

We define the velocity g=v_{c}−\hat{v}_{c}, with \hat{v}_{c}=[0,0,\hat{v}]^{T}. Using this definition, we express z as z=gₙ−μεₛF(∥gₜ∥/εₛ)+\hat{v}. We notice that [symbol] (z) is constant (no contact) for z≥\hat{v}. In terms of g, this is equivalent to gₙ−μεₛF(∥gₜ∥/εₛ)≥0. The graph of gₙ=μεₛF(∥gₜ∥/εₛ) defines the boundary of the stick-slip transition, and therefore when F(s) is convex, its epigraph (the set of points above its graph), corresponds to a convex region (not necessarily a cone as in previous work). This is illustrated in FIG. 3. In this plot, contour levels of [symbol] (∥gₜ∥,gₙ) correspond to lines of constant z, which by definition are perpendicular to the gradient ∂ [symbol] /∂v_{c}. We see that the role of the potential [symbol] is to penalize g when it lies outside the epigraph of gₙ=μεₛF(∥gₜ∥/εₛ).

Consider F(s)=\sqrt{s²+1}−1, for which g˜=μ∥gₜ∥ₛ. The epigraph of this function is an approximation to the dual F* of the friction cone F, as shown in FIG. 3. This approximation is F* in the limit εₛ→0. Moreover, in the limit to rigid contact, [symbol] enforces g∈F*, which corresponds to the cone constraint in the primal formulation.

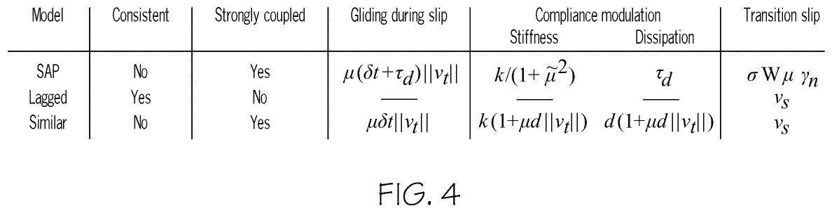

The three models discussed above, SAP, Lagged, Similar, are convex approximations of contact, each with its own strengths and limitations. In particular, FIG. 4 summarizes the properties and artifacts of the three different model approximations.

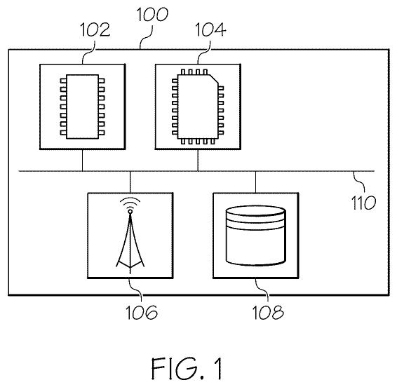

Turning now to FIG. 1, a computing device 100 is depicted for performing the operations described above. In particular, the computing device 100 may be used to receive a model of contact forces, process the model to obtain an approximation of the model, and using the approximation of the model to simulate a mechanical system with frictional contact.

In the example of FIG. 1, the computing device 100 comprises one or more processors 102, one or more memory modules 104, network interface hardware 106, a data storage component 108, and a communication path 110. The one or more processors 102 may be a controller, an integrated circuit, a microchip, a computer, or any other computing device. The one or more memory modules 104 may comprise RAM, ROM, flash memories, hard drives, or any device capable of storing machine readable and executable instructions such that the machine readable and executable instructions can be accessed by the one or more processors 102.

The network interface hardware 106 can be communicatively coupled to the communication path 108 and can be any device capable of transmitting and/or receiving data via a network. Accordingly, the network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 106 includes hardware configured to operate in accordance with the Bluetooth® wireless communication protocol.

The data storage component 108 may store data received by the network interface hardware 106. The data storage component 108 may also store data used by the one or more memory modules 104, discussed in further detail below.

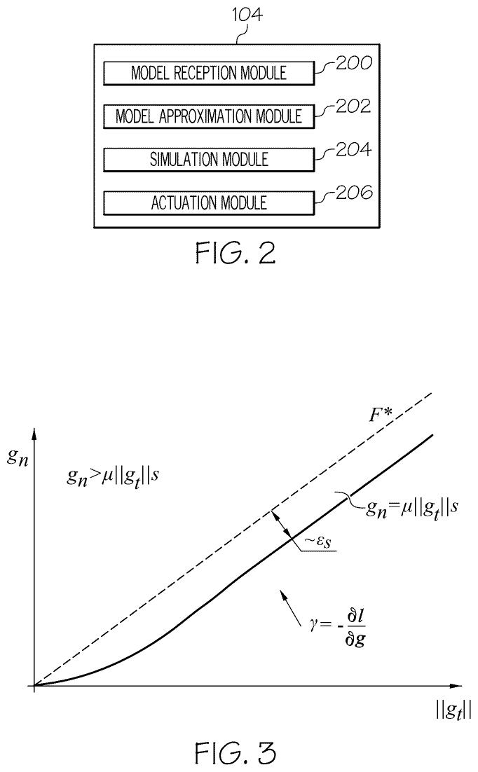

FIG. 2 schematically illustrates the memory modules 104. As shown in FIG. 2, the one or more memory modules 104 include a model reception module 200, a model approximation module 202, and a simulation module 204. Each of the model reception module 200, the model approximation module 202, and the simulation module 204 may be a program module in the form of operating systems, application program modules, and other program modules stored in the one or more memory modules 104. In some embodiments, the program module may be stored in a remote storage device that may communicate with the computing device 100. Such a program module may include, but is not limited to, routines, subroutines, programs, objects, components, data structures and the like for performing specific tasks or executing specific data types as will be described below.

The model reception module 200 may receive a model of contact forces. In particular, the model reception module 200 may receive a model of contact forces associated with a mechanical system. The model of contact forces may be input by a user. For example, a user may determine a model of contact forces based on experimental data, or a user may select a known or predetermined model of contact forces. One example model of contact forces that may be received by the model reception module 200 is shown in equation (15) above. As discussed above, the model of contact forces received by the model reception module 200 may not be solvable. As such, the computing device 100 may determine an approximation of the model of contact forces received by the model reception module 200, as disclosed herein.

Referring still to FIG. 2, the model approximation module 202 may process the model of contact forces received by the model reception module 200 to obtain an approximation of the model. In particular, the model approximation module 202 may process the model to determine an approximation of the model that satisfies the curl condition of equation (17) above. As discussed above, the model reception module 202 may determine a family of model approximations that satisfy the curl condition, including the SAP approximation, the Lagged approximation, and the Similar approximation. As discussed above, each of these models has different advantages and disadvantages, and a user may select a particular one of these models that the model approximation module 202 may use to determine an approximation of the model received by the model reception module 200. In embodiments, the model approximation module 202 may use the approximation determined by the model approximation module 202 to solve the optimization problem of equation (3) above.

Referring still to FIG. 2, the simulation module 204 may use the approximation determined by the model approximation module 202 to simulate a mechanical system with frictional contact over time. In some examples, the simulation module 204 may utilize Drake, a robotics toolkit that provides modeling abstractions and optimization tools for the modeling, simulation, and analysis of robotics systems. Embodiments may include support for deformable Finite Element Models (FEM), holonomic constraints, PD controllers with effort limits, reflected inertia, and the modeling of continuous contact patches with Hydroelastic Contact.

The SAP approximation uses Newton's method to compute a search direction Av for equation (3) according to

$$H ( v ) Δ v = - r ( v ) , \qquad ( 25 )$$

where r(v)=∂ [symbol] /∂v is the residual of the primal cost [symbol] (v), and H(v) is its Hessian. Upon convergence, the residual r(v) is zero, which is equivalent to the linearized balance of momentum (2). The solution at iteration m is updated as

$${v}_{m + 1} = {v}_{m} + α Δ v ,$$

with a determined via a line search along Δv to minimize [symbol] (v). In embodiments, the line search uses a Newton-Raphson method, augmented with bracketing and bisection to guarantee convergence. The derivatives required for the line search are computed with O(n) complexity, enabling convergence to machine precision with negligible computational overhead. This strategy has proven to be very robust in practice.

Multibody tree structures create distinct cliques, while degrees of freedom (DOFs) for modeling a deformable body are also grouped into their own cliques. Similarly, constraints involving the same pair of cliques are grouped into clusters. In embodiments, this structure is exploited using a supernodal Cholesky factorization of the Hessian H in (25) that takes advantage of dense algebra optimizations. We compute the elimination ordering of the supernodes using approximate minimum degree (AMD) ordering to minimize fill-ins.

In embodiments, the implementation in Drake provides an end-to-end solution for the computation of gradients through contact for applications such as system identification, reinforcement learning, and trajectory optimization. We implement a novel hybrid approach that utilizes automatic differentiation to propagate gradients of the Featherstone's dynamics and geometry through the SAP formulation via the implicit function theorem.

We denote the differentiation parameters with θ∈ε [symbol] , which can include physical quantities such as mass and inertias, contact parameters, actuation, and even the previous state of the multibody system. Using this notation, SAP's optimality condition can be written in terms of the residual in (25) as r(v;θ)=0. In this notation, the residual is a function of the generalized velocities v given a set of parameters θ.

We use the implicit function theorem on r(v;θ)=0, and note that ∂r/∂v=H(v) to write

$$H \frac{d v}{d θ} = - \frac{\partial r ( v ; θ )}{\partial θ} \qquad ( 26 )$$

In our approach, the expensive-to-compute Cholesky factorization of H is only computed at each Newton iteration in (25) during forward simulation. Upon convergence, H is already assembled and factorized and is thus reused in (26) an additional n_{θ} times to propagate derivatives through the solver into gradients dv/dθ of the generalized velocities.

In our hybrid approach, ∂r/∂θ in (26) is computed with automatic differentiation. This enables the computation of gradients through arbitrarily complex geometric models, while the implicit function theorem propagates derivatives accurately and efficiently through the contact resolution phase.

Referring still to FIG. 2, the actuation module 206 may actuate a mechanical component based on the simulation results obtained by the simulation module 204. In particular the actuation module 206 may cause a mechanical component of a mechanical system to move based on the simulation results. For example, the simulation module 204 may simulate the motion of a mechanical system involving a robotic arm, and the actuation module 206 may actuate a motor of the robotic arm based on the results of the simulation. For example, the actuation module 206 may actuate a mechanical component of a mechanical system (e.g., a robotic arm) to achieve a particular state of the mechanical system based on the simulation results of the simulation module 204.

In one example, the actuation module 206 may utilize the simulation results obtained by the simulation module 204 to determine an optimal trajectory for a robotic arm to move an object. The actuation module 206 may use the simulation results to solve for an optimal trajectory involving contact between the robotic arm and the object. The actuation module 206 may then actuate the robotic arm to move the object along the determined trajectory.

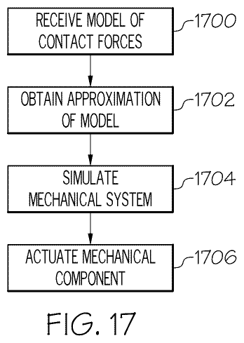

FIG. 17 depicts a flowchart of an example method for operating the computing device 100 for generating convex approximations of complex contact models. At step 1700, the model reception module 200 receives a model of contact forces. At step 1702, the model approximation module 202 processes the model of contact forces received by the model reception module 200 to obtain an approximation of the model satisfying a curl condition. At step 1704, the simulation module 204 uses the approximation of the model determined by the model approximation module 202 to simulate a mechanical system with frictional contact over time. At step 1706, the actuation module 206 actuates a mechanical component of the mechanical system based on the simulation results performed by the simulation module 204.

Discussed below are a series of two-dimensional test cases to assess accuracy, quantify artifacts introduced by the convex approximations, and gain intuition into the physics and numerics.

For all cases, we use vₛ=10⁻⁴ m/s for the Lagged and Similar approximations, and σ=10⁻³ for the SAP approximation, leading to very tight stiction modeling as desired for simulating manipulation tasks.

We estimate contact stiffness using Hertz theory. For a sphere of mass m and radius R, Hertz theory predicts a penetrationδ=(3 mg/rER^{1/2})^{2/3}. For steel with Young's modulus E=200 GPa and using the radii and masses discussed above, we obtain penetrations around δ≈2.5×10⁻⁷ m and stiffnesses k≈1×10⁻⁷-2×10⁷ N/m. We use k=10⁷ N/m for all cases discussed below.

For some cases, we perform a convergence study where we compute the error in the positions q_{dt} obtained using step size St against a reference q_{ref} as a function of the time step size

$${e}_{q} ( δ t ) = {( \frac{1}{T} {\int }_{0}^{T} dt {‖ {q}_{δ t} ( t ) - {q}_{ref} ( t ) ‖}^{2} )}^{1 / 2}$$

where T is simulation duration. The reference solution is obtained numerically using a time step 10 times smaller than the smallest time step in the convergence study. Since the Lagged approximation is the only approximation that is consistent, we use it to compute the reference solution.

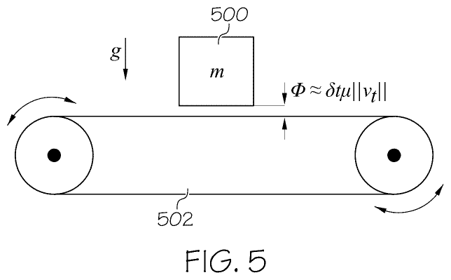

A first example test case is an oscillating conveyor belt, illustrated in FIG. 5. In the example of FIG. 1 a 1 kg box 500 with 5 cm sides is placed on a conveyor belt 502 oscillating at 1 Hz with 0.2 m amplitude. Friction is p=0.7. Even though dissipation models are different, using d=500 s/m for Similar and Lagged and τ_{d}=10⁻³ s for SAP yields comparable dissipation.

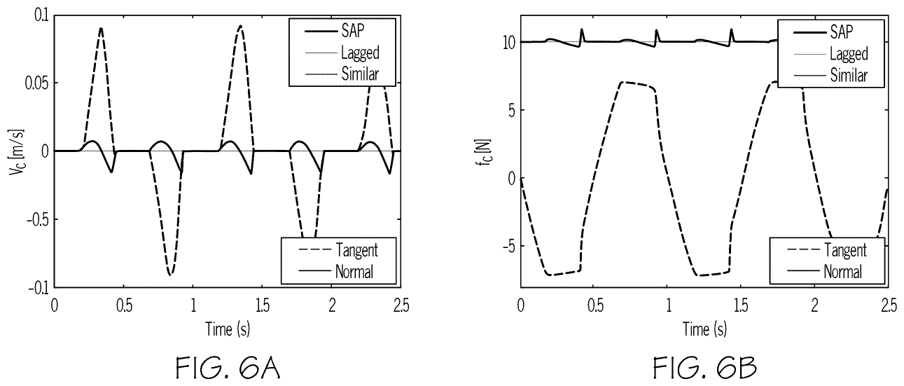

FIG. 6A shows contact velocity and FIG. 6B shows force computed using δt=0.01 s. Contact between the box 500 and the conveyor belt 502 transitions back and forth between stiction and sliding. The Lagged approximation predicts no vertical motion, with the normal force balancing the box's weight as expected. However, the SAP and Similar approximations show artifacts in the normal direction during sliding, which disappears in stiction. Additional, we observe spurious transients in the normal force during sliding—as slip speed changes so does gliding, causing vertical acceleration and thus normal force fluctuations. Finally, SAP and Similar introduce normal force spikes during the abrupt transition from sliding to stiction, when gliding vanishes causing a sudden normal velocity change.

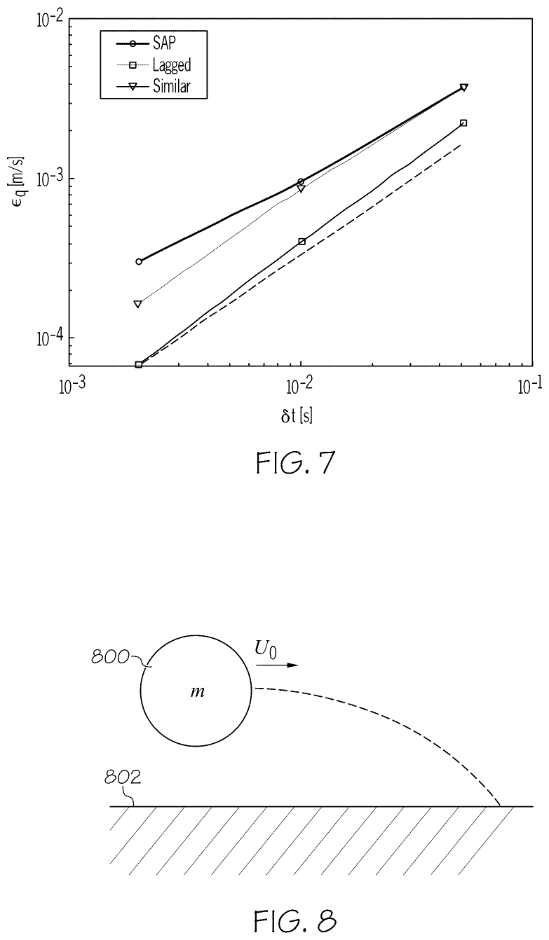

FIG. 7 shows a convergence study with step sizes δt∈{2×10⁻³, 10⁻², 5×10⁻²}. Both Lagged and Similar approximations exhibit first order convergence, as expected, though the artifacts introduced by Similar cause higher errors than Lagged. Finally, SAP's error plateaus at the smallest time step due to model inconsistency, where the term γ_{d}μ∥vₜ∥ does not vanish as time step decreases.

Another example test case is a falling sphere, as illustrated in FIG. 8. In this example, a 0.5 kg steel sphere 800 that is 5 cm in diameter falls from a height of 5 cm towards a surface 802 with an initial horizontal velocity U₀=2 m/s. Friction with the surface 802 is μ=0.5 Upon impact, the sphere 800 slides, and then transitions to rolling as friction induces angular momentum. After this transition, friction ceases to dissipate energy. We model compliant contact with stiffness k=10⁷ N/m and dissipation constants d=500 s/m, and τ_{d}=10⁻³ s.

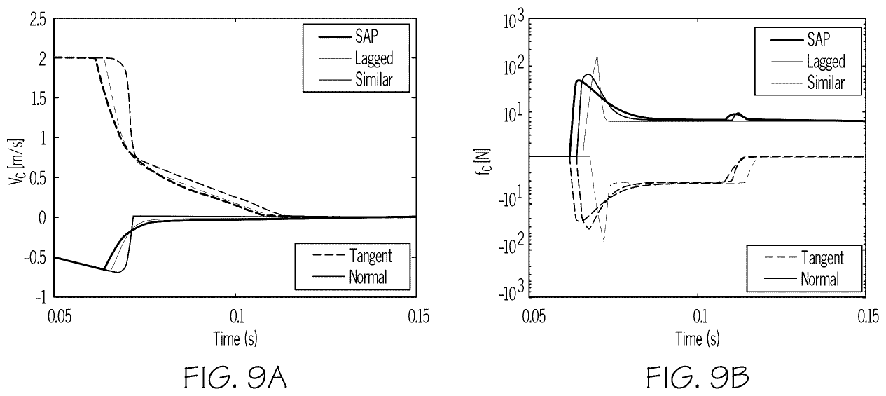

FIG. 9A shows contact velocity and FIG. 9B shows force computed with δt=2×10⁻³ s. In the force plots, both SAP and Similar initiate contact earlier due to the action at a distance artifact in these convex models, with SAP engaging even earlier due to the non-vanishing term τ_{d}μ∥vₜ∥. The sphere 800 slides from initial contact until about t=0.07 s, when it transitions to rolling. While Lagged brings normal velocity to zero almost instantly, SAP and Similar approximations link normal velocity to slip velocity, only reaching zero at stiction. During the sliding-to-stiction transition, we observe a rapid normal force spike, as with the conveyor belt problem of FIG. 5. This artifact is absent with the Lagged approximation.

A convergence study with step sizes δt∈{4×10⁻⁴, 2×10⁻³, 10⁻²} is shown in FIG. 10. While all of these schemes are first order, SAP exhibits a constant error at convergence due to the τ_{d}∥vₜ∥ term.

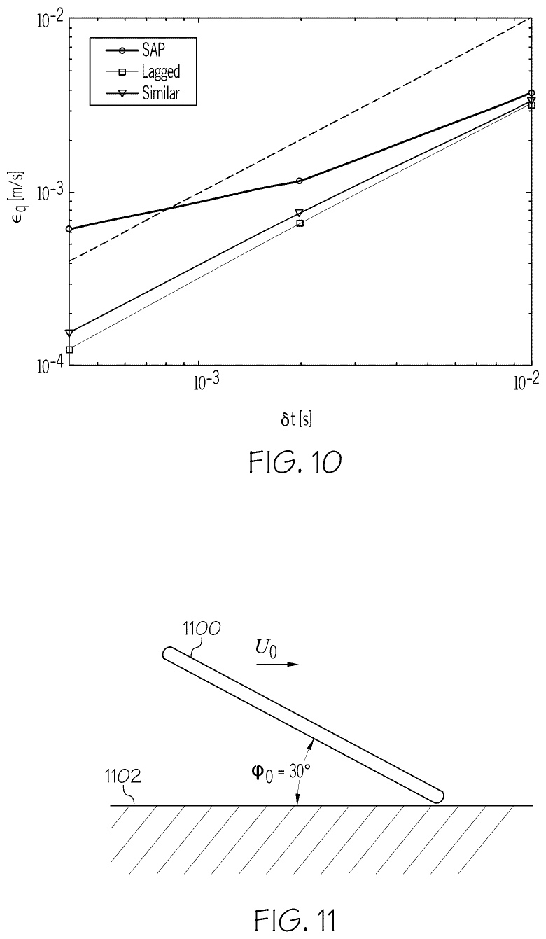

Another example test case is a sliding rod, illustrated in FIG. 11. In the example of FIG. 11, a rod 1100 is initially angled with a surface 1102 and makes single-point contact with a horizontal velocity. As it slides, friction rotates the rod 1100 into the surface 1102, increasing the normal force. Under specific conditions, both normal and frictional forces intensify, potentially leading to a singularity in acceleration-level formulations with Coulomb friction known as Painlevé paradox, where forces become infinite. This problem is resolved in the discrete setting, where finite impulses and discrete velocity changes are allowed. Physically, bodies aren't perfectly rigid—they deform, vibrate, and may even undergo plastic (permanent) deformations. Nonetheless, a rapidly increasing contact force develops an impact that makes the rod jam into the ground and jump into the air. The rod 1100 of FIG. 11 measures 0.5 m in length, 1 cm in diameter, and has a mass of 0.3 kg.

Analytical analysis shows that the singularity occurs when μ>4/3 and the initial kinetic energy overcomes potential energy as the rod's center of gravity rises and friction dissipates energy. We set μ=2.3, a 30° initial angle, and an initial horizontal speed U₀=10 m/s.

Using a reference solution with a time step of δt=10⁻⁷ s and no normal force dissipation, we observe that the rod 1100 rotates upward and jams into the surface 1102 upon contact as expected. All three model approximations yield similar results, as the compliant model is identical in the absence of dissipation, differing only in friction regularization. Pre-impact forces oscillate based on ground compliance, and impact location is nearly identical across the model approximations despite being very sensitive to model parameters.

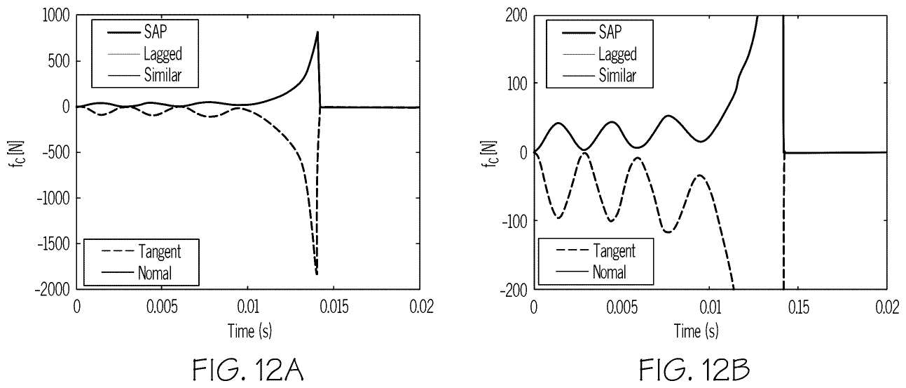

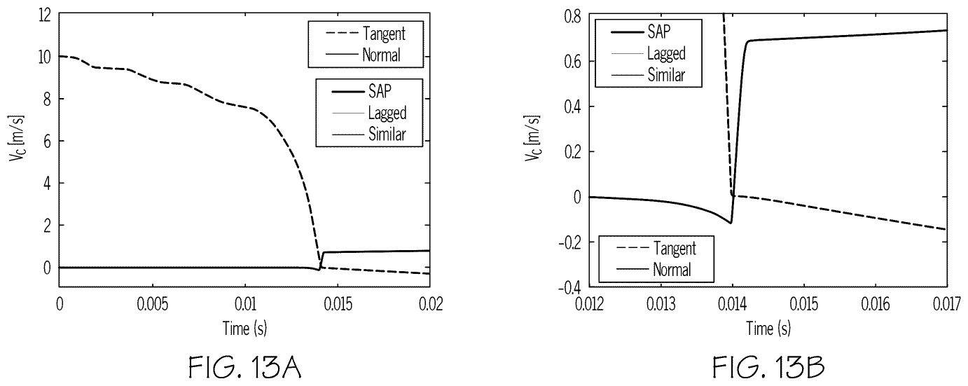

FIG. 12A shows contact forces in the case with zero dissipation. FIG. 12B shows a close-up of FIG. 12A near the impact. FIG. 13A shows contact velocities as the contact point moves into the ground due to large contact forces until the tangential component of the velocity goes to zero and the rod 1100 jams into the surface 1102. FIG. 13B shows a close-up of FIG. 13A near the impact. During stiction, ∥vₜ∥<vₛ for a finite period of about 0.2 ms.

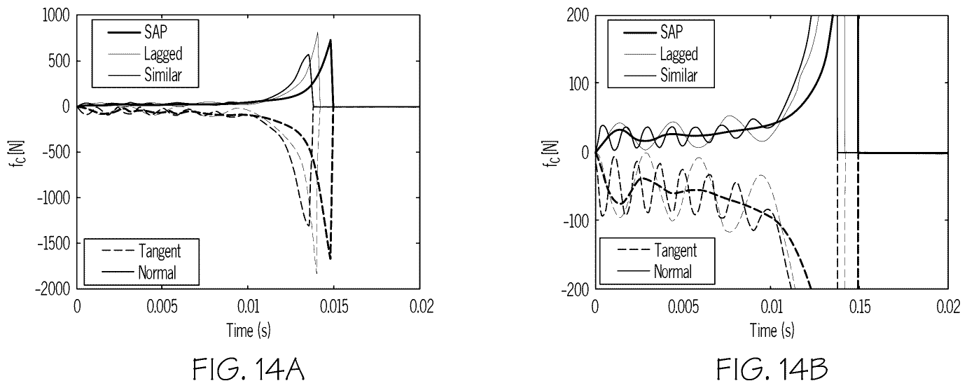

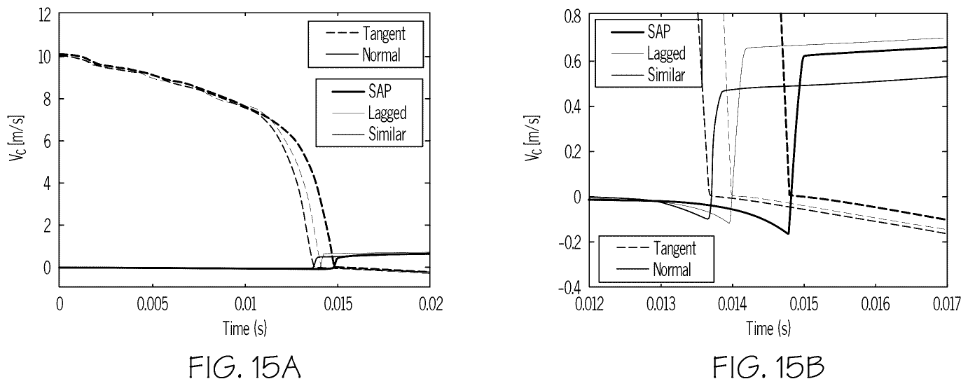

We run the simulation with Hung & Crossley dissipation d=0.2 s/m and relaxation time ρ_{d}=4.0×10⁻⁶ s. These low dissipation values have minimal effect on the time of impact for the Lagged approximation, our reference solution, as seen in FIGS. 14A, 14B, 15A, and 15B. FIG. 14A shows contact forces in the case with dissipation. FIG. 14B shows a close-up near the impact. FIG. 15A shows contact velocities in the case with dissipation. FIG. 15B shows a close-up near the impact.

However, Similar and SAP approximations predict shifted impact times-earlier for Similar, later for SAP. Although their contact forces and velocities differ significantly, we choose τ_{d} for SAP to match the shift in time of impact observed in the Similar approximation, albeit in the opposite direction. Compliance modulation in the Similar approximation becomes evident in FIGS. 14A and 14B, where we observe a frequency shift on the force oscillations. This is caused by the larger effective stiffness of the model during sliding, k_{eff}=k(1+μ∥vₜ∥d).

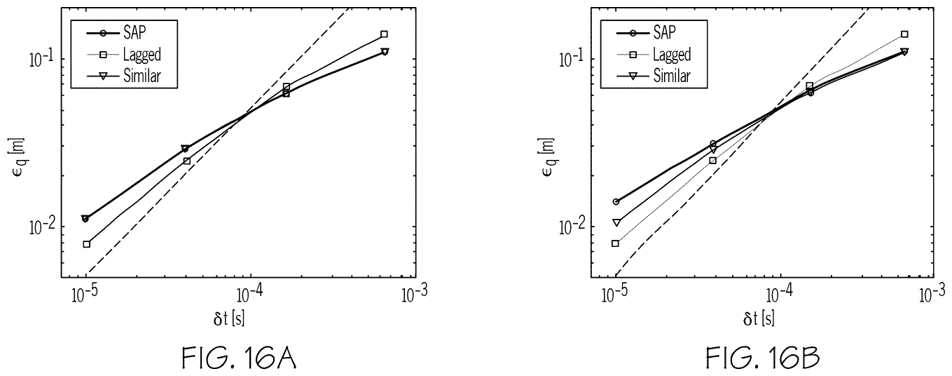

A convergence analysis is shown with dissipation in FIG. 16A and without dissipation in FIG. 16B, using time steps δt={6.4×10⁻⁴, 1.6×10⁻⁴, 4.0×10⁻⁵, 1.0×10⁻⁵} s. Without dissipation, SAP and Similar solutions are indistinguishable. The Lagged approximation exhibits the largest error at the largest time step, revealing a limitation: its lagged normal force affects Coulomb friction modeling in rapidly changing scenarios, even missing impacts when δt>10⁻³ s. However, it achieves first-order convergence with smaller steps. Similar trends occur with non-zero dissipation, though the curves diverge as time of impact predictions shift.

It should now be understood that embodiments described herein are directed to a framework for convex approximations of complex contact models. The disclosed mathematical framework establishes a family of convex approximations of frictional contact. This framework enables incorporation of complex physics-based models of contact, such as the Hunt & Crossley model, within a convex formulation. These models, grounded in physics and experimentally validated, have the potential to narrow the sim2real gap. The disclosed approximations are well-suited for the modeling of most robotic tasks.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving a model of contact forces;
processing the model to obtain a convex approximation of the model satisfying a curl condition; and
using the approximation of the model to simulate a mechanical system with frictional contact over time.

2. The method of claim 1, wherein the curl condition comprises a curl of the contact forces being equal to zero.

3. The method of claim 1, further comprising solving a Partial Differential Equation associated with the curl condition.

4. The method of claim 1, further comprising:
incorporating the convex approximation of the model into an optimization problem;
solving the optimization problem; and
using a solution to the optimization problem to simulate the mechanical system with frictional contact over time.

5. The method of claim 4, further comprising determining a regularizing term associated with the optimization problem.

6. The method of claim 1, wherein a solution to the curl condition comprises a normal impulse that is lagged to a previous time step.

7. The method of claim 1, wherein a solution to the curl condition comprises grouping independent variables associated with the model into a single variable in the convex approximation.

8. The method of claim 1, further comprising actuating a mechanical component based on a simulation of the mechanical system.

9. A computing device comprising one or more processors configured to:
receive a model of contact forces;
process the model to obtain a convex approximation of the model satisfying a curl condition; and
use the approximation of the model to simulate a mechanical system with frictional contact over time.

10. The computing device of claim 9, wherein the curl condition comprises a curl of the contact forces being equal to zero.

11. The computing device of claim 9, wherein the one or more processors are further configured to solve a Partial Differential Equation associated with the curl condition.

12. The computing device of claim 9, wherein the one or more processors are further configured to:
incorporate the convex approximation of the model into an optimization problem;
solve the optimization problem; and
use a solution to the optimization problem to simulate the mechanical system with frictional contact over time.

13. The computing device of claim 12, wherein the one or more processors are further configured to determine a regularizing term associated with the optimization problem.

14. The computing device of claim 9, wherein a solution to the curl condition comprises a normal impulse that is lagged to a previous time step.

15. The computing device of claim 9, wherein a solution to the curl condition comprises grouping independent variables associated with the model into a single variable in the convex approximation.

16. The computing device of claim 9, wherein the one or more processors are further configured to actuate a mechanical component based on a simulation of the mechanical system.

17. A non-transitory computer-readable storage medium, storing machine readable instructions in one or more memory modules that, when executed by one or more processors, cause one or more processors to:
receive a model of contact forces;
process the model to obtain a convex approximation of the model satisfying a curl condition; and
use the approximation of the model to simulate a mechanical system with frictional contact over time.

18. The non-transitory computer-readable storage medium of claim 15, wherein the instructions further cause the one or more processors are further to:
incorporate the convex approximation of the model into an optimization problem;
solve the optimization problem; and
use a solution to the optimization problem to simulate the mechanical system with frictional contact over time.

19. The non-transitory computer-readable storage medium of claim 15, wherein a solution to the curl condition comprises a normal impulse that is lagged to a previous time step.

20. The non-transitory computer-readable storage medium of claim 15, wherein a solution to the curl condition comprises grouping independent variables associated with the model into a single variable in the convex approximation.
